(19) United States
(12) Patent Application Publication
(10) Pub. No.: US 2018/0260363 A1
(43) Pub. Date: Sep. 13, 2018

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Satoshi TAKUMI, Kanagawa (JP)

(73) Assignee: FUJI XEROX CO., LTD., Tokyo (JP)

(21) Appl. No.: 15/802,409

(22) Filed: Nov. 2, 2017

(30) Foreign Application Priority Data
Mar. 9, 2017 (JP) 2017-045332

(51) Int. Cl. G06F 17/21; G06F 17/28

(52) U.S. Cl. CPC G06F 17/212; G06F 17/2863

(57) ABSTRACT

An image processing apparatus includes an acquisition unit that acquires image information, and an output unit that in a case where there is an area having a degree of a difference between a state before translation and a state after translation in translation of a document included in an image, among areas in the image, exceeding a predetermined degree, outputs information indicating the position of the area in the image.

### CROSS-REFERENCE TO RELATED APPLICATIONS

This application is based on and claims priority under 35 USC 119 from Japanese Patent Application No. 2017-045332 filed Mar. 9, 2017.

### BACKGROUND

### Technical Field

The present invention relates to an information processing apparatus and a non-transitory computer readable medium storing a program.

### SUMMARY

According to an aspect of the invention, there is provided an information processing apparatus including an acquisition unit that acquires image information, and an output unit that in a case where there is an area having a degree of a difference between a state before translation and a state after translation in translation of a document included in an image, among areas in the image exceeding a predetermined degree, outputs information indicating the position of the area in the image.

### BRIEF DESCRIPTION OF THE DRAWINGS

Exemplary embodiment(s) of the present invention will be described in detail based on the following figures, wherein:

FIG. 1 shows an example of a hardware configuration of an image processing apparatus according to an exemplary embodiment;

FIG. 2 is a block diagram illustrating an example of a functional configuration of the image processing apparatus according to the exemplary embodiment;

FIG. 3 is a flowchart showing an example of a series of processing procedures by the image processing apparatus;

FIGS. 4A and 4B are diagrams for explaining an example of a process in which a correction area detection unit detects a correction area;

FIG. 5 is a flowchart showing an example of processing procedure in which the correction area detection unit detects the correction area;

FIGS. 6A and 6B are diagrams showing a display example of a translation result and layout collapse information;

FIG. 7 is a diagram showing a display example of candidates for a correction procedure; and

FIG. 8 is a diagram showing an example of a hardware configuration of a computer to which the exemplary embodiment can be applied.

### DETAILED DESCRIPTION

Hereinafter, an exemplary embodiment of the present invention will be described in detail with reference to the accompanying drawings.

Hardware Configuration of Image Processing Apparatus

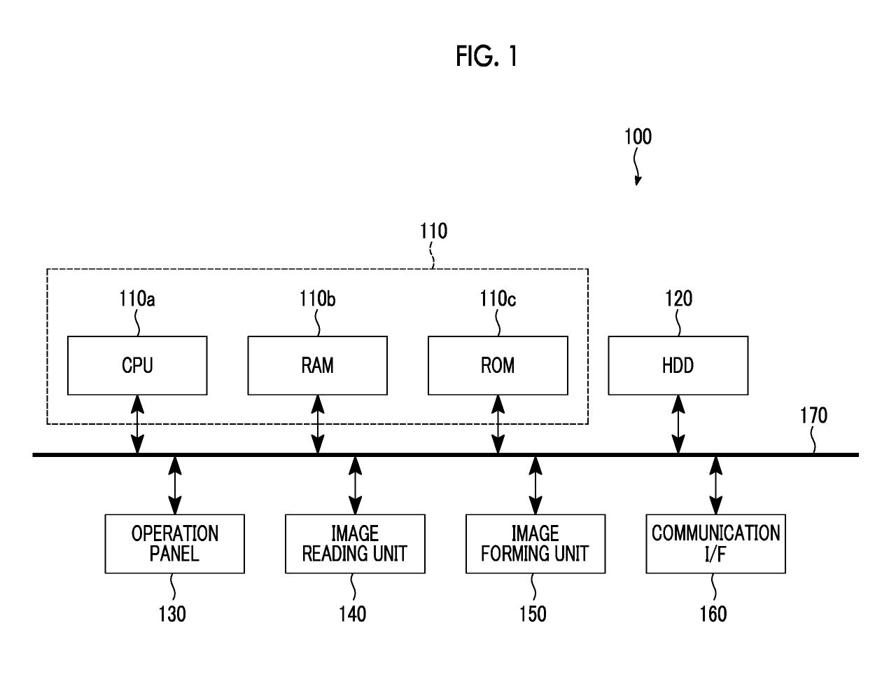

First, the hardware configuration of an image processing apparatus 100 according to the exemplary embodiment will be described. FIG. 1 is a diagram illustrating an example of the hardware configuration of the image processing apparatus 100 according to the exemplary embodiment. The image processing apparatus 100 according to the present exemplary embodiment is, for example, a so-called multifunction machine having various image processing functions such as an image reading function (scanning function), a print function, a copy function, and a facsimile function. Further, in the present exemplary embodiment, the image processing apparatus 100 is used as an example of the information processing apparatus.

As shown in FIG. 1, the image processing apparatus 100 according to the present exemplary embodiment includes a controller 110, a hard disk drive (HDD) 120, an operation panel 130, an image reading unit 140, an image forming unit 150, and a communication interface (hereinafter referred to as “communication I/F”) 160. These function units are connected to a bus 170, and exchange data through the bus 170.

The controller 110 controls each unit of the image processing apparatus 100. The controller 110 includes a central processing unit (CPU) 110a, a random access memory (RAM) 110b, and a read only memory (ROM) 110c.

The CPU 110a loads various programs stored in the ROM 110c or the like into the RAM 110b and executes the programs to realize the respective functions in the image processing apparatus 100. The RAM 110b is a memory (storage unit) used as a working memory or the like of the CPU 110a. The ROM 110c is a memory (storage unit) that stores various programs or the like executed by the CPU 110a.

The HDD 120 is a storage unit that stores various types of data. In the HDD 120, for example, image data generated by image reading of the image reading unit 140, image data received from the outside by the communication I/F 160, and the like are stored.

The operation panel 130 displays various types of information, and receives an operation from the user. The operation panel 130 includes a display panel formed of a liquid crystal display or the like, a touch panel disposed on the display panel for detecting a position touched by the user, physical keys pressed by the user, and the like. Then, the operation panel 130 displays, for example, various screens such as an operation screen of the image processing apparatus 100 on the display panel, or receives an operation from the user through the touch panel and the physical keys.

The image reading unit 140 reads an image formed on a recording material such as paper set on the platen, and generates image information (image data) indicating the read image. Here, the image reading unit 140 is, for example, a scanner. A CCD type in which reflected light for light irradiated on a document from a light source is condensed by a lens and received by a charge coupled device (CCD) or a CIS type in which reflected light for light irradiated on an original document from an LED light source is received by a contact image sensor (CIS) may be used therefor.

The image forming unit 150 is a printing mechanism that forms an image on a recording material such as paper. Here, the image forming unit 150 is, for example, a printer, and an electrophotographic type in which toner attached to a photoreceptor is transferred to a recording material to form an image, or an inkjet type in which an image is formed by ejecting ink onto a recording material may be used therefor.

The communication I/F 160 is a communication interface that transmits and receives various data to and from other devices through a network (not shown).

In the image processing apparatus 100, under the control of the controller 110, the scanning function is realized by the image reading unit 140, the printing function is realized by the image forming unit 150, the copy function is realized by the image reading unit 140 and the image forming unit 150, and the facsimile function is realized by the image reading unit 140, the image forming unit 150 and the communication I/F 160.

Functional Configuration of Image Processing Apparatus

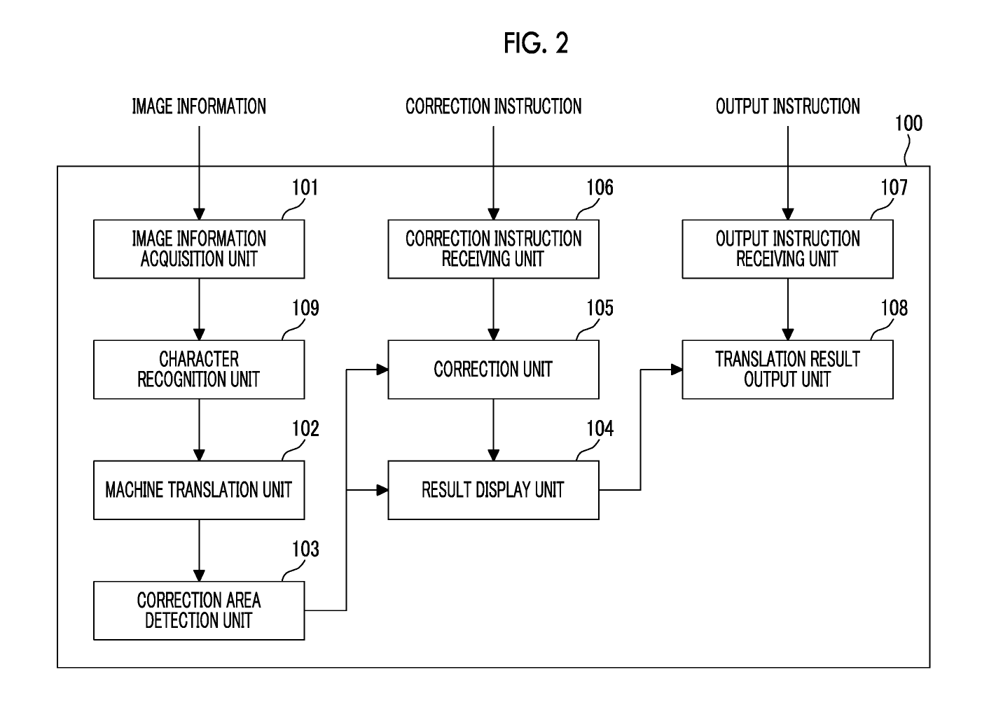

Next, the functional configuration of the image processing apparatus 100 according to the present exemplary embodiment will be described. FIG. 2 is a block diagram illustrating an example of a functional configuration of the image processing apparatus 100 according to the present exemplary embodiment.

The image processing apparatus 100 according to the present exemplary embodiment includes an image information acquisition unit 101 that acquires image information to be subjected to machine translation, a character recognition unit 109 that recognizes characters included in the image, a machine translation unit 102 that translates (machine-translates) the document in the image, a correction area detection unit 103 that detects a place where layout collapse due to translation occurs, and a result display unit 104 that displays translation result and layout collapse information. Further, the image processing apparatus 100 includes a correction unit 105 that corrects layout collapse, a correction instruction receiving unit 106 that receives from the user a correction instruction for layout collapse, an output instruction receiving unit 107 that receives an instruction to output a translation result from a user, and a translation result output unit 108 that outputs a translation result.

The image information acquisition unit 101 acquires image information to be subjected to machine translation. Here, the image information acquisition unit 101 acquires, for example, image information generated by the image reading unit 140 reading an image formed on a recording material such as paper. Further, the image information acquisition unit 101 may acquire, for example, image information sent from another apparatus through the communication I/F 160.

The character recognition unit 109 performs character recognition by performing, for example, an optical character recognition (OCR) process on the image information acquired by the image information acquisition unit 101. The OCR is a technique of analyzing characters on image data and converting them into character data handled by a computer.

More specifically, the character recognition unit 109 first divides the image specified by the image information acquired by the image information acquisition unit 101 into one or plural areas. The area division is performed by a known method in the related art, and division is performed for each component constituting an image, based on information such as the size of a character, the width between lines, and a ruled line. Examples of the components of the image include a document object, a table object, a figure object, an image object such as a photograph (so-called bitmap image), or the like. If area division of an image is performed, the character recognition unit 109 performs character recognition by a process such as optical character recognition (OCR) or the like, in each divided area.

The machine translation unit 102 translates a document in the image specified by the image information acquired by the image information acquisition unit 101. As the translation, for example, translation from English (an example of the first language) to Japanese (an example of the second language) and the like are exemplified.

More specifically, the machine translation unit 102 translates a document disposed in a predetermined layout in each divided area. Then, the document after translation is disposed at the position where the document before translation is disposed. Furthermore, the constituent elements other than the document are also disposed at the position where they were disposed before the translation. In this way, the machine translation unit 102 generates image information after translation.

It may be set not to perform translation by machine translation unit 102, depending on the type of an area. For example, regarding the area of the image object, it may be set such that translation by the machine translation unit 102 is not to be performed irrespective of whether or not a document is included in the area.

In a case where character information of each area is already known, in the image information acquired by the image information acquisition unit 101, the character recognition unit 109 does not perform character recognition, and the machine translation unit 102 may perform machine translation.

The correction area detection unit 103 compares the layout of the document in the image information before translation (that is, the image information acquired by the image information acquisition unit 101) with the layout of the document in the image information after translation (layout after translation) to detect the location where layout collapse due to translation occurs. Here, the layout collapse means that the positions of the text and the image in the document greatly change with respect to the whole document, depending on before and after the translation. In other words, the correction area detection unit 103 compares the layout of the document in the image information before translation with the layout of the document in the image information after translation to detect an area having a difference between the two layouts (hereinafter, referred to as a correction area). The correction area detected here can be regarded as an area in which the degree of a difference between the state before translation and the state after translation among one or plural areas included in the image exceeds a predetermined degree.

More specifically, the correction area detection unit 103 compares the state before translation with the state after translation for each divided area. Then, for each area, the degree of the difference between the state before translation and the state after translation is calculated. In a case where there is an area where the degree of a difference exceeds a predetermined degree, the area is detected as a correction area. Details of the process of detecting the correction area will be described later.

The result display unit 104 displays the layout collapse information and translation result on the operation panel 130. Here, the result display unit 104 displays the image after translation as a translation result. In addition, the result display unit 104 displays information indicating the position of the correction area in the image after translation, as the layout collapse information.

In addition, the result display unit 104 displays a candidate for a correction procedure for correcting the difference between the state before translation and the state after translation for the correction area. As will be described later, when the correction is performed according to the correction procedure selected by the user, the result display unit 104 displays the image after translation in which the correction is reflected.

The correction instruction receiving unit 106 receives a correction instruction for layout collapse from the user. In other words, the correction instruction receiving unit 106 receives from the user, an instruction to correct the difference between the state before translation and the state after translation of the correction area.

More specifically, for example, when the user selects the candidate for the correction procedure presented by the result display unit 104 on the operation panel 130, the correction instruction receiving unit 106 receives a correction instruction by the selected correction procedure. For example, the user may directly edit the image information after translation. In this case, the correction instruction receiving unit 106 receives an instruction to edit the image information after translation.

The correction unit 105 corrects the layout collapse according to the correction instruction received by the correction instruction receiving unit 106. In other words, according to the correction instruction received by the correction instruction receiving unit 106, the correction unit 105 corrects the difference between the state before translation and the state after translation of the correction area.

More specifically, for example, in a case where the user selects a candidate for a correction procedure, the correction unit 105 corrects the image information after translation according to the selected correction procedure. Further, for example, in a case where the user directly edits the image information after translation, the correction unit 105 corrects the image information after translation in which the editing is reflected.

The output instruction receiving unit 107 receives an instruction to output the translation result from the user. More specifically, for example, when the user selects to output the translation result on the operation panel 130, the output instruction receiving unit 107 receives an output instruction. Here, the output instruction receiving unit 107 also receives an instruction as to what format the translation result is to be output. As the format of the output, for example, a recording material such as paper, electronic data or the like is exemplified.

The translation result output unit 108 outputs the translation result, according to the output instruction received by the output instruction receiving unit 107. Here, the translation result output unit 108 outputs the translation result in which the correction by the correction unit 105 is reflected, (that is, the image information after translation in which the correction by the correction unit 105 is reflected), according to the output instruction received by the output instruction receiving unit 107.

More specifically, for example, the translation result output unit 108 outputs the image information after translation in which the correction by the correction unit 105 is reflected and issues a print instruction, to the image forming unit 150. For example, the translation result output unit 108 outputs the image information after translation in which the correction by the correction unit 105 is reflected, to an output destination device designated by the user, through the communication I/F 160.

Each functional unit constituting the image processing apparatus 100 shown in FIG. 2 is realized by cooperation of software and hardware resources. More specifically, in a case where the image processing apparatus 100 is realized by the hardware configuration shown in FIG. 1, for example, an OS program stored in the ROM 110c and application programs are read into the RAM 110b and executed by the CPU 110a to realize the functional units of the image information acquisition unit 101, the machine translation unit 102, the correction area detection unit 103, the result display unit 104, the correction unit 105, the correction instruction receiving unit 106, the output instruction receiving unit 107, the translation result output unit 108, the character recognition unit 109, and the like.

In the present exemplary embodiment, the image information acquisition unit 101 is used as an example of an acquisition unit. The result display unit 104 is used as an example of an output unit and a presentation unit. The machine translation unit 102 is used as an example of a replacement unit. The correction area detection unit 103 is used as an example of a comparison unit.

Description of Procedure of Series of Processes by Image Processing Apparatus

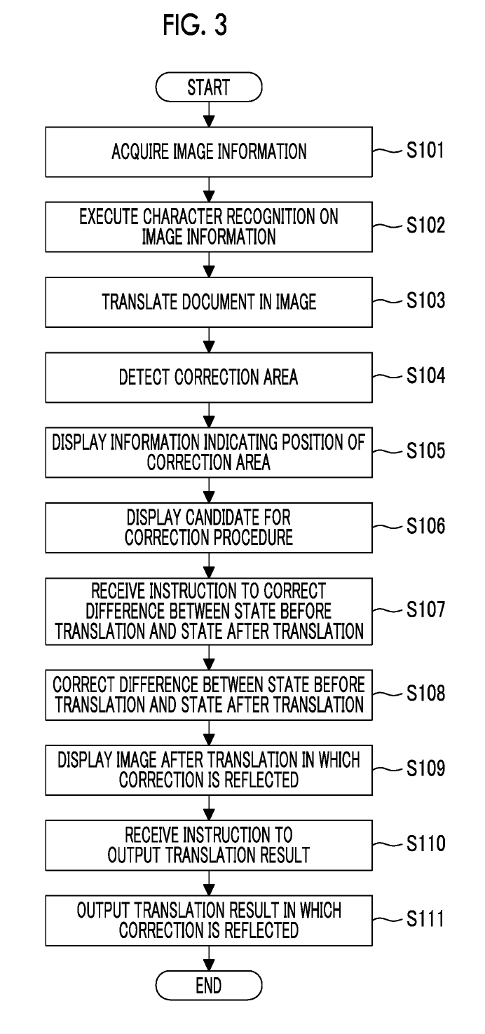

Next, a series of processing procedures by the image processing apparatus 100 will be described. FIG. 3 is a flowchart showing an example of a series of processing procedures by the image processing apparatus 100.

First, the image information acquisition unit 101 acquires image information to be subjected to machine translation (step 101). Next, the character recognition unit 109 executes character recognition by performing, for example, an OCR process, on the image information acquired by the image information acquisition unit 101 (step 102). Next, the machine translation unit 102 translates the document in the image specified by the image information acquired by the image information acquisition unit 101 (step 103). Here, the document is translated for each of one or plural areas to generate image information after translation.

Next, the correction area detection unit 103 compares the image information before translation with the image information after translation, and detects a correction area in which the degree of the difference between the state before translation and the state after translation exceeds a predetermined degree (step 104). Next, the result display unit 104 displays information indicating the position of the correction area present in the image after translation (step 105). In addition, the result display unit 104 displays a candidate for a correction procedure for correcting the difference between the state before translation and the state after translation of the correction area (step 106).

Next, the correction instruction receiving unit 106 receives an instruction to correct the difference between the state before translation and the state after translation of the correction area (step 107). Here, the correction instruction is received by the user selecting the candidate for the correction procedure presented in step 106 or directly editing the image information. In addition, the user may select plural correction procedure candidates, or select the presented correction procedure and directly edit the image information.

Next, according to the correction instruction received by the correction instruction receiving unit 106, the correction unit 105 corrects the difference between the state before translation and the state after translation of the correction area (step 108). In a case where the user selects plural correction procedure candidates in step 107, correction is performed by the plural correction procedures. In addition, in a case where the user selects the presented correction procedure and directly edits the image information, the correction by the correction procedure is performed and the editing by the user is also reflected.

Next, the result display unit 104 displays the image after translation in which the correction by the correction unit 105 is reflected (step 109). Until the user completes the correction, the process from step 106 to step 109 is repeatedly executed.

Next, the output instruction receiving unit 107 receives an instruction to output the translation result (step 110). Next, the translation result output unit 108 outputs the translation result in which the correction by the correction unit 105 is reflected, according to the output instruction received by the output instruction receiving unit 107 (step 111). Then, the process flow is ended.

Description of Process of Detecting Correction Area

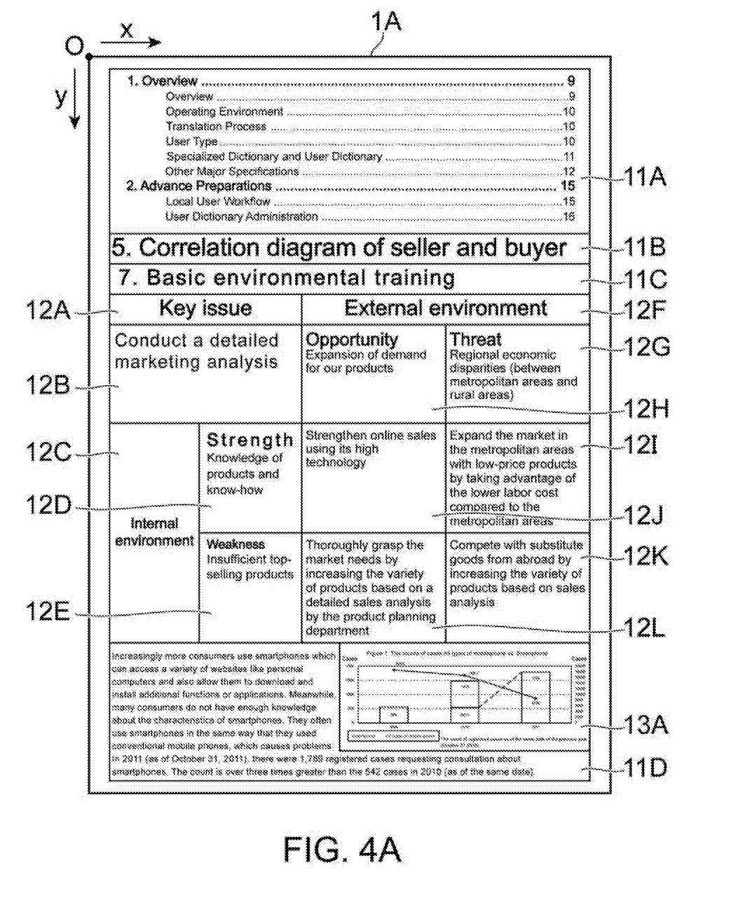

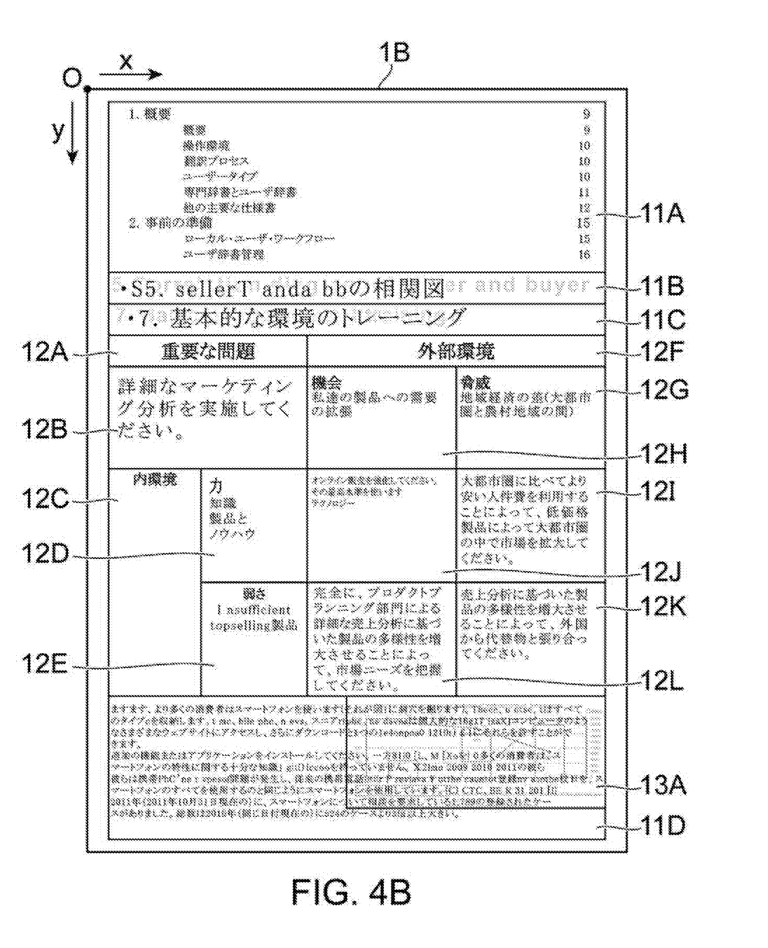

Next, a process in which the correction area detection unit 103 detects a correction area will be described. FIGS. 4A and 4B are diagrams for explaining an example of a process in which the correction area detection unit 103 detects a correction area. The image 1A shown in FIG. 4A is an image before translation (image information), and the image 1B shown in FIG. 4B is an image after translation (image information).

Consider a Cartesian coordinate system in the image 1A and image 1B shown in FIGS. 4A and 4B. Specifically, for example, the corner at the upper left in each of the image 1A and image 1B in FIGS. 4A and 4B is set as the origin O, the x axis is defined in the right direction and the y axis is defined in the downward direction in FIGS. 4A and 4B. Then, the coordinate in the horizontal direction (left-and-right direction in FIGS. 4A and 4B) of the image 1A and image 1B is set as an x coordinate, and the coordinate in the vertical direction (up-and-down direction in FIGS. 4A and 4B) of the image 1A and image 1B is set as a y coordinate.

The image 1A is divided into plural areas based on the constituent elements constituting the image 1A. In the illustrated example, it is divided into document object areas 11A to 11D, table object areas 12A to 12L, and a figure object area 13A. Among the document object areas, an area 11A is divided as an itemization area, and areas 11B to 11D are divided as a sentence area.

Further, the image 1B is an image in which a document included in the image 1A is translated and the document after translation is disposed. Similar to the image 1A, the image 1B is divided into document object areas 11A to 11D, table object areas 12A to 12L, and a figure object area 13A. In other words, the areas of the image 1B correspond to the areas of the image 1A, respectively, and the position of each area in the image 1B is the same as the position of each area in the image 1A. For example, the position (coordinate) of the area 11A in the image 1B is the same as the position (coordinate) of the area 11A in the image 1A.

Then, the correction area detection unit 103 compares an image 1A before translation with an image 1B after translation. More specifically, the correction area detection unit 103 compares the state before translation and the state after translation for each area in the image to calculate the degree of the difference. Here, the correction area detection unit 103 determines, for each pixel in the area, whether the pixel value after translation is within a certain range from the pixel value before translation. For example, it is determined whether the pixel value (R, G, B) after translation is within a certain range from the pixel value (R, G, B) before translation. A pixel whose pixel value after translation is within a certain range from the pixel value before translation is set as a matching pixel, and a pixel whose pixel value after translation exceeds a certain range from the pixel value before translation is set as a mismatching pixel.

In this manner, the correction area detection unit 103 classifies all pixels in the area into matching pixels and mismatching pixels. Then, the correction area detection unit 103 calculates the ratio occupied by mismatching pixels (hereinafter, referred to as a degree of inconsistency) among all the pixels in the area. In a case where there is an area where the degree of inconsistency exceeds a predetermined degree (for example, 30%), the area is detected as a correction area.

More specifically, since the languages of the document are different before and after translation, images do not completely match before and after translation. However, in a case where the layout before translation is maintained even after translation, it is assumed that the ratio of matching pixels increases and the proportion of mismatching pixels decreases. Therefore, in the present exemplary embodiment, it is assumed that the layout before translation is maintained even after translation even for an area where the degree of inconsistency is a predetermined degree or less. On the other hand, with respect to areas having the degree of inconsistency exceeding the predetermined degree, it is assumed that the layout before translation is not maintained after translation and layout collapse does not occur.

For example, a case of comparing the state before translation and the state after translation with respect to the area 11A shown in FIGS. 4A and 4B will be described. In this case, with respect to each pixel in the area 11A, the correction area detection unit 103 determines whether the pixel value after translation is a value within a certain range from the pixel value before translation. For example, a pixel (coordinates x1, y1) included in the area 11A of the image 1A is compared with a pixel at the same position in the image 1B, that is, a pixel (coordinate x1, y1) included in the area 11A of the image 1B. Further, for example, a pixel (coordinates x2, y2) included in the area 11A of the image 1A is compared with the pixel (coordinates x2, y2) included in the area 11A of the image 1B. In this manner, all pixels in the area 11A are classified into matching pixels and mismatching pixels. Then, it is determined whether or not the ratio of mismatching pixels to all the pixels in the area 11A, that is, the degree of inconsistency of the area 11A exceeds a predetermined degree.

In the illustrated example, the ratio of mismatching pixels does not exceed a predetermined degree in the area 11A, and the area 11A does not correspond to the correction area. In other words, the layout of the area 11A is maintained before and after the translation, and the collapse of the layout does not occur.

On the other hand, in the areas 11B, 12C, and 13A, the ratio of mismatching pixels exceeds a predetermined degree, and the areas are detected as correction areas. In other words, the layouts are not maintained in the areas 11B, 12C, 13A before and after translation, and the collapse of the layout occurs.

For example, in the area 11B, decorative characters are added to the original text before translation. As a result of translating the original text, the image of the decorative characters of the original text remain even after the translation.

Further, for example, in the area 12C, the position of the document is greatly different between before translation and after translation.

For example, in the area 13A, the document after translation of the adjacent area 11D protrudes into the area 13A without being broken and covers the figure object of the area 13A.

In this manner, in the areas 11B, 12C, 13A, the layouts are not maintained before and after translation and the ratio of mismatching pixels exceeds a predetermined degree, so the areas are detected as correction areas.

Processing Procedure for Detecting Correction Area

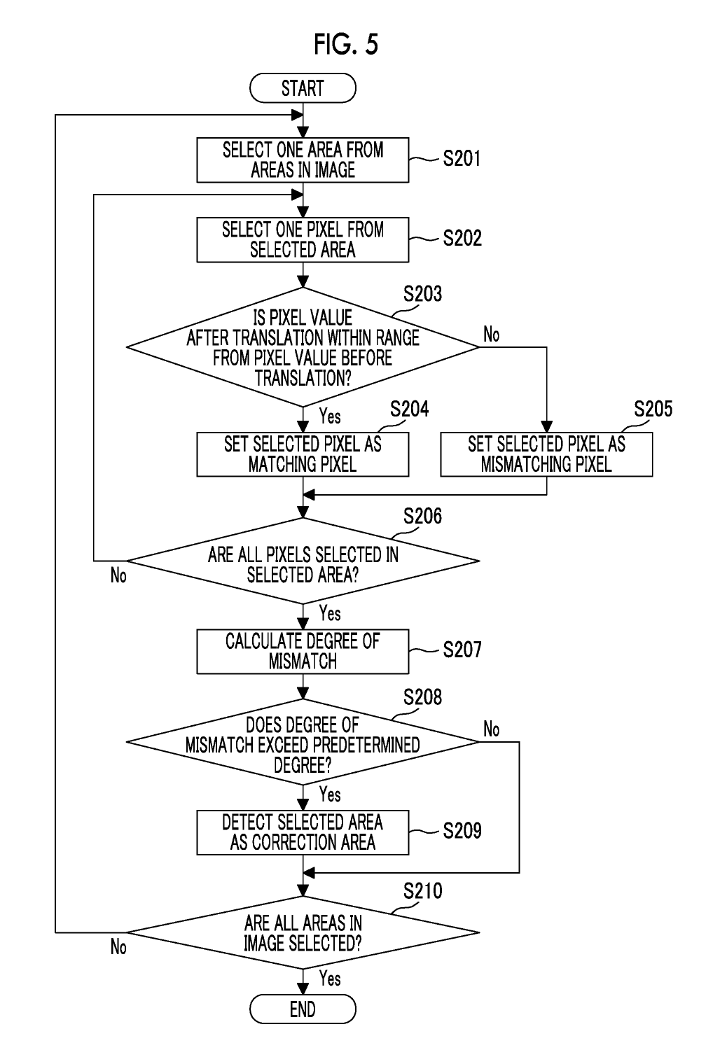

Next, processing procedure in which the correction area detection unit 103 detects a correction area will be described. FIG. 5 is a flowchart showing an example of processing procedure in which the correction area detection unit 103 detects the correction area. The process in FIG. 5 is the process of step 104 shown in FIG. 3, which is performed after the process in step 103 in FIG. 3 (translation by the machine translation unit 102).

First, the correction area detection unit 103 selects one area from one or plural areas in the image (step 201). Here, the correction area detection unit 103 selects areas at the same position (coordinate) one by one from the image before translation and the image after translation. Next, the correction area detection unit 103 selects one pixel from the selected area (step 202). Here, the correction area detection unit 103 selects pixels at the same position (coordinate) one by one from the area before translation and the area after translation.

Next, with respect to the selected pixel, the correction area detection unit 103 determines whether the pixel value after translation is a value within a certain range from the pixel value before translation (step 203). In a case where a positive determination (Yes) is made in step 203, the correction area detection unit 103 sets the selected pixel as a matching pixel (step 204). On the other hand, in a case where a negative determination (No) is made in step 203, the correction area detection unit 103 sets the selected pixel as a mismatching pixel (step 205).

Next, the correction area detection unit 103 determines whether all pixels have been selected, in the area selected in step 201 (step 206). In a case where a positive determination (Yes) is made in step 206, the process proceeds to step 207 to be described later. On the other hand, in a case where a negative determination (No) is made in step 206, the process proceeds to step 202, and pixels that have not yet been selected are selected.

Next, in step 207, the correction area detection unit 103 calculates a degree of inconsistency, which is the ratio of mismatching pixels to all the pixels in the area selected in step 201 (step 207). Next, the correction area detection unit 103 determines whether or not the calculated degree of inconsistency exceeds a predetermined degree (step 208). In a case where a positive determination (Yes) is made in step 208, the correction area detection unit 103 detects this area (that is, the area selected in step 201) as a correction area (step 209).

After step 209 or in a case where a negative determination (No) is made in step 208, the correction area detection unit 103 determines whether all areas in the image have been selected (step 210). In a case where a positive determination (Yes) is made in step 210, this processing flow is ended. On the other hand, in a case where a negative determination (No) is made in step 210, the process proceeds to step 201, and an area which has not yet been selected is selected.

Display Example of Translation Result and Layout Collapse Information

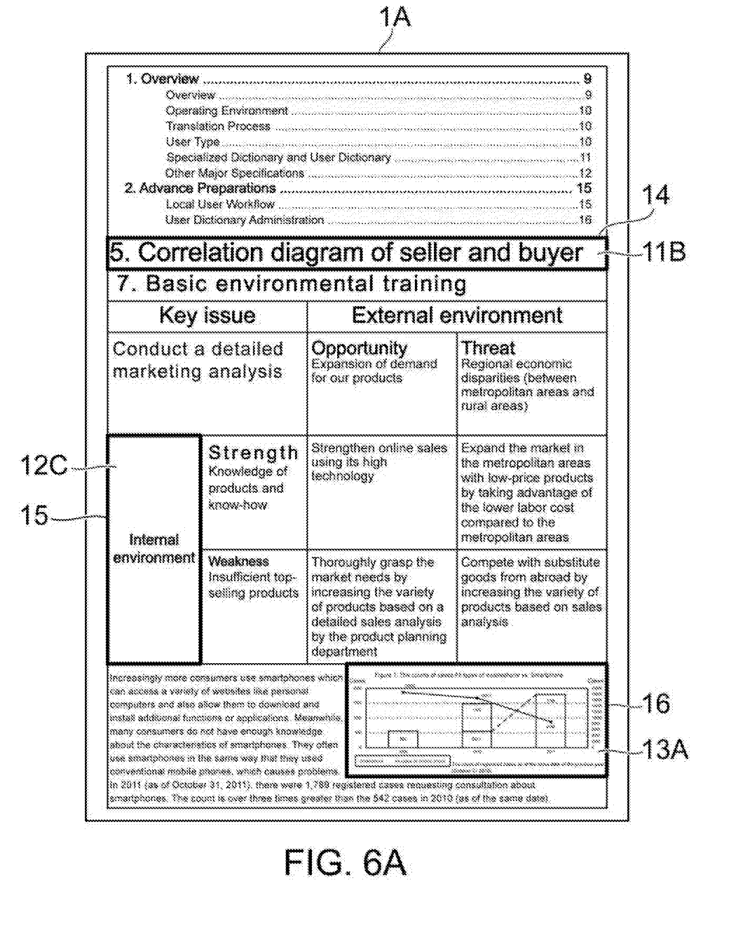

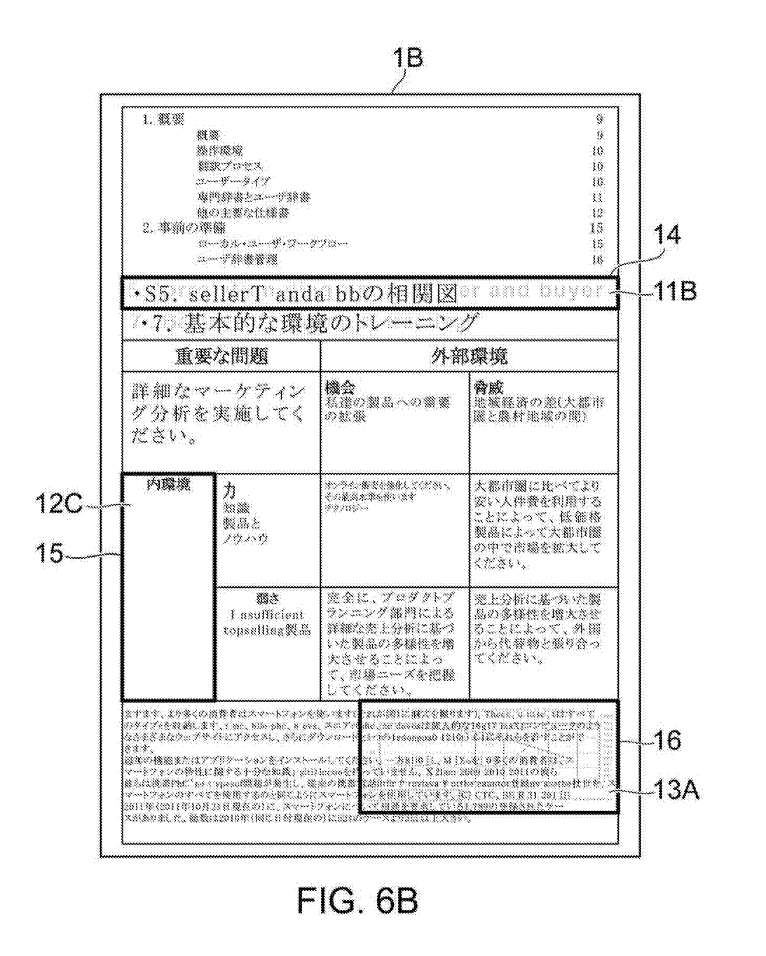

Next, a translation result and layout collapse information displayed by the result display unit 104 will be described. FIGS. 6A and 6B show a display example of a translation result and layout collapse information. Here, an image 1A shown in FIG. 6A is an image before translation similar to FIG. 4A. In addition, an image 1B shown in FIG. 6B is an image after translation similar to FIG. 4B, and shows the translation result. As examples shown in FIGS. 4A and 4B, a description will be given on the assumption that the area 11B, the area 12C, and the area 13A are detected as the correction area as a result of translating the document of the image 1A.

The result display unit 104 displays the information indicating the position of the correction area as the layout collapse information, and presents the position of the correction area to the user. In the shown example, the result display unit 104 displays the image surrounding the periphery of the correction area (hereinafter referred to as the surrounding image). In other words, the surrounding image is an image added in a predetermined range from the correction area. In the shown example, the result display unit 104 displays the image 14 surrounding the periphery of the area 11B, the image 15 surrounding the periphery of the area 12C, and the image 16 surrounding the periphery of the area 13A.

However, the information indicating the position of the correction area is not limited to the case of displaying the surrounding image. For example, an image showing a value (for example, 50%) of the degree of inconsistency of the correction area may be displayed in a predetermined range from the correction area, and the position of the correction area may be presented to the user. Further, for example, an image showing the type (for example, a document object, a table object, or the like) of the correction area may be displayed in a predetermined range from the correction area, and the position of the correction area may be presented to the user.

Further, the result display unit 104 may change the information indicating the position of the correction area, depending on the degree of inconsistency. For example, the color and pattern of the surrounding image may be changed depending on the degree of inconsistency. For example, the surrounding image of the correction area showing the degree of inconsistency of 80% or more is red, the surrounding image of the correction area showing the degree of inconsistency is 50 to 80% is yellow, and the surrounding image of the correction area showing the degree of inconsistency of 30 to 50% is blue. Further, for example, in a case of displaying an image showing the value of the degree of inconsistency of the correction area in a predetermined range from the correction area, the information to be displayed changes depending on the degree of inconsistency.

Further, the result display unit 104 may change the information indicating the position of the correction area, depending on the type of the correction area. For example, the color and pattern of the surrounding image may be changed depending on the type of the correction area. For example, the surrounding image is red in a case where the correction area is a document object, the surrounding image is yellow in a case where the correction area is a table object, the surrounding image is blue in a case where the correction area is a figure object, and the surrounding image is green in a case where the correction area is an image object. Further, for example, in a case of displaying an image showing the type of the correction area in a predetermined range from the correction area, the information to be displayed changes depending on the type of the correction area.

The result display unit 104 may display plural pieces of information with respect to the correction area. For example, for each correction area, a surrounding image is displayed, and an image showing the value of the degree of inconsistency or an image showing the type of the correction area may be displayed. Here, in a case of displaying the surrounding image, the image showing the value of the degree of inconsistency or the image showing the type of the correction area may not be displayed in the predetermined range from the correction area.

Description of Candidate for Correction Procedure

Next, candidates for the correction procedure displayed by the result display unit 104 will be described. As a candidate for the correction procedure, for example, plural forms such as “change font size”, “change document position”, “re-translation into short sentence”, “wrap-around designation”, “change area”, and “display original text as it is”.

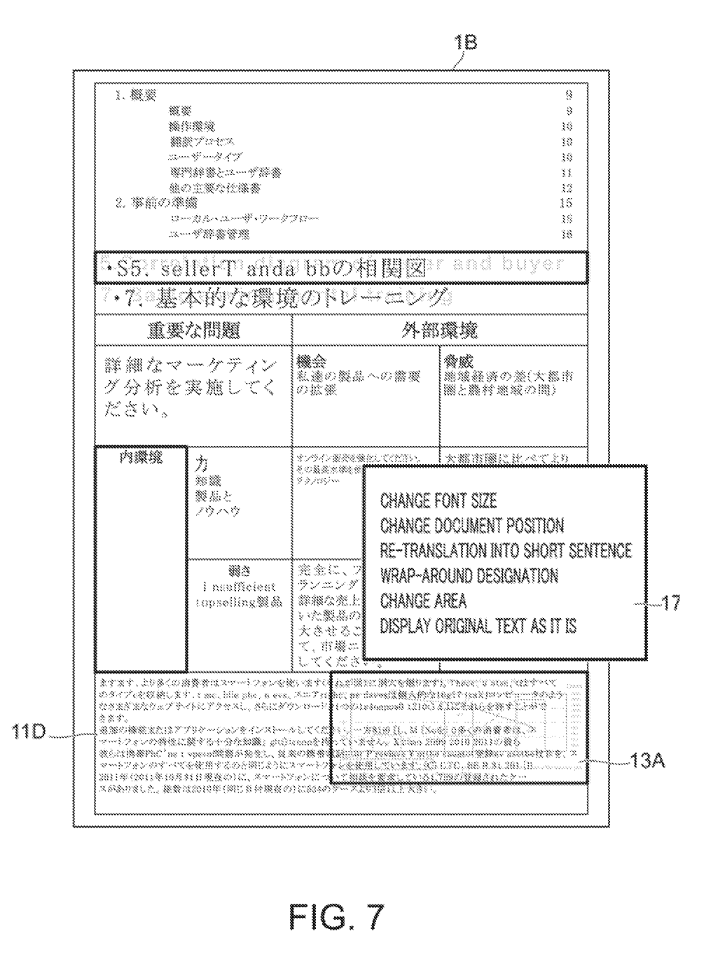

FIG. 7 is a diagram showing a display example of candidates for a correction procedure. The image 1B shown in FIG. 7 is an image after translation similar to FIG. 4B and FIG. 6B.

In the case of performing a correction by the correction procedure, the user first selects an area to be corrected by the correction procedure. When the user selects an area, candidates for a correction procedure to be applied to the area are displayed. In the illustrated example, it is assumed that the user selects the area 13A on the screen. When the user selects the area 13A, an image 17 showing a list of candidates for a correction procedure applied to the area 13A is displayed. For example, when the user selects “change font size”, correction of “change font size” is performed for the area 13A. Then, the image after translation is displayed again in a state in which the correction is reflected in the area 13A.

The area to be corrected is not limited to the correction area. For example, in the area 13A in each of FIGS. 4A and 4B, the document in the area 11D protrudes and covers the figure in the area 13A. Here, although the area 11D is not detected as a correction area, the degree of inconsistency of the area 13A may be corrected by correcting the document in the area 11D. In such a case, the user may select the area 11D which is not the correction area and correct the area 11D. Further, for example, as the area 11A in FIGS. 4A and 4B, an area which is not a correction area and does not affect the degree of inconsistency for the other area may be corrected, of course.

Next, the correction procedure candidates will be specifically described.

“Change font size” is a process of changing the font size of a document in the area. For example, by decreasing the font size of a document, the portion hidden by the document is displayed without being hidden, or the document is displayed without protruding to other areas.

In a case where the user selects “change font size” as a correction procedure, for example, plural candidates for the changed font size are displayed. Then, for example, when the user selects any one font size from the displayed candidates, the font size of the document in the area is changed to the font size selected by the user, and the image after translation is displayed again.

“Change document position” is a process of changing the position of a document in the area. For example, in a case where the position of the document differs greatly before and after translation as the area 12C in FIGS. 4A and 4B, the position is changed such that the document after translation is disposed at the same position as the document before translation.

In a case where the user selects “change document position” as a correction procedure, for example, as a candidate for the document position, vertical alignment (top alignment, center alignment, and bottom alignment) and horizontal alignment (left alignment, center alignment, and right alignment) are displayed. Then, for example, when the user selects any one of the displayed document position candidates, the position of the document in the area is changed, and the image after translation is displayed again.

“re-translation into short sentences” is a process of re-translating a document in the area into short sentences. For example, in machine translation, the document after translation may be much longer than the original sentence, depending on the language after translation. Therefore, the machine translation unit 102 re-translates the document into short sentences, by using abbreviated acronyms, or by describing it in concise grammar.

In a case where the user selects “re-translation into short sentences” as a correction procedure, for example, the machine translation unit 102 re-translates the documents in the area. Then, the image including the document after the re-translation is displayed again.

“Wrap-around designation” is a process of performing line feed on a document protruding from another area such that the document does not protrude from another area but to fit into a designated area. For example, in the area 13A in each of FIGS. 4A and 4B, the document in the area 11D protrudes and covers the figure in the area 13A. Here, for example, in a case where the user selects “wrap-around designation” as the correction procedure for the area 13A, line feed is performed on a document protruding from the other area into the area 13A, that is, a document in the area 11D, and the document is displayed so as not to protrude to the area 13A but to fit into the area 11D.

“Change area” is a process for changing the range of the area in which the document is displayed so that the document fits within the changed area. For example, in the area 13A in each of FIGS. 4A and 4B, the document in the area 11D protrudes and covers the figure in the area 13A. In other words, the area 13A is included as the area in which the document in the area 11D is displayed. Here, for example, in a case where the user selects “change area” as a correction procedure for the area 11D, the user is notified to change the area where the document is displayed. Then, if the user designates an area that does not include the area 13A, that is, an area of the area 11D, as the area in which the document in the area 11D is to be displayed, line feed is performed on the document in the area 11D. Then, the document in the area 11D is displayed so as not to protrude into the area 13A and fit into the area 11D.

“Display original text as it is” is a process of displaying the original sentence without translating the document in the area. By displaying the original text as it is, the original text is displayed in a state in which layout collapse due to translation has not occurred. In a case where the user selects “display original text as it is” as a correction procedure, the document in the area, as it is, is displayed as an image after translation.

In addition, the result display unit 104 may not change the candidates for the correction procedure to be displayed, in accordance with the type of the correction area, instead of displaying all of the candidates for these correction procedures. For example, in a case where the correction area is a document object, four forms of “change font size”, “re-translation into short sentence”, “change area”, and “display original text as it is” may be displayed. For example, in a case where the correction area is a figure object, two forms of “change document position” and “wrap-around designation” may be displayed.

As described above, the image processing apparatus 100 according to the present exemplary embodiment detects a correction area in which a difference between the state before translation and the state after translation exceeds a predetermined degree, from among areas in the image. Then, the image processing apparatus 100 presents the position of the detected correction area to the user, and presents the candidate for the correction procedure to the user. Further, the image processing apparatus 100 corrects the difference between the state before translation and the state after translation of the correction area in accordance with the correction instruction by the user, and displays the translation result in which the correction is reflected.

In this way, the image processing apparatus 100 detects locations where layout collapse occurs due to translation, and corrects the layout collapse. Therefore, by using the image processing apparatus 100 according to the present exemplary embodiment, for example, compared to a case where user compares the state before translation and the state after translation while checking the screen, the complexity of determination as to the occurrence of the layout collapse due to translation can be reduced.

Further, in the present exemplary embodiment, as described above, the correction area detection unit 103 detects a correction area having a degree of a difference between a state before translation and a state after translation exceeding a predetermined degree, but it is not limited to a configuration in which a predetermined degree is fixedly determined and a correction area is detected. For example, the value of the degree of inconsistency calculated for each area in the image may be relatively evaluated and set to a predetermined degree.

More specifically, the correction area detection unit 103 may relatively evaluate the value of the degree of inconsistency calculated for each area in the image, and set the value satisfying a specific condition as a predetermined degree. For example, a predetermined degree is set such that the ratio of areas having the value of the degree of inconsistency exceeding the predetermined degree to areas in the image is N % (specific ratio). In other words, for example, the correction area detection unit 103 may detect, as correction areas, areas having the value of the degree of inconsistency included in the top N %, from among areas in the image.

Further, for example, a predetermined degree is set such that the number of areas having the value of the degree of inconsistency exceeding the predetermined degree among areas in the image is N (a specific number). In other words, for example, the correction area detection unit 103 may select and detect, as correction areas, N areas having values of the degree of inconsistency in descending order from the top, among areas in the image.

Description of Applicable Computer

Meanwhile, the process by the image processing apparatus 100 according to the present exemplary embodiment is realized by, for example, a general-purpose computer such as a personal computer (PC).

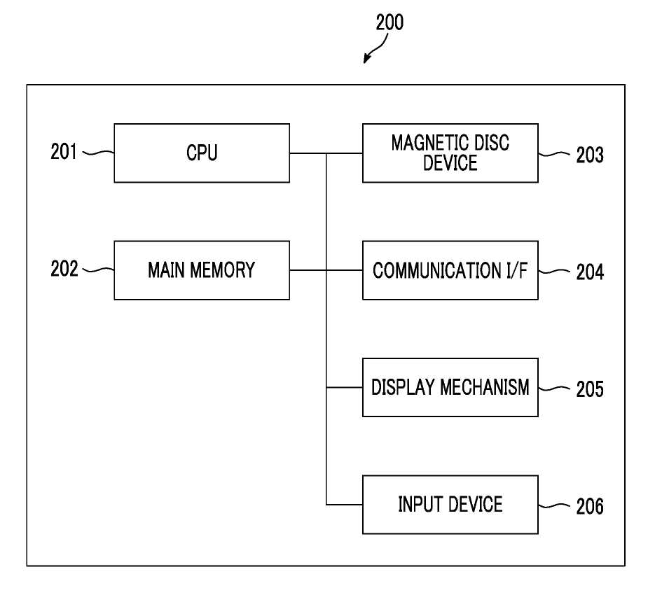

Therefore, the hardware configuration of the computer 200 will be described as realizing this process. FIG. 8 is a diagram showing an example of a hardware configuration of a computer 200 to which the exemplary embodiment can be applied. Further, in the present exemplary embodiment, the computer 200 is used as an example of the information processing apparatus.

The computer 200 includes a CPU 201 which is a calculation unit, a main memory 202 and a magnetic disc device (HDD) 203 which are storage units. Here, the CPU 201 executes various programs such as OS and applications. The main memory 202 is a storage area for storing various programs and data used for the execution thereof, and the magnetic disk device 203 stores a program for realizing each functional unit shown in FIG. 2. Then, the program is loaded into the main memory 202, and the process based on the program is executed by the CPU 201, thereby each functional unit is realized.

Further, the computer 200 includes a communication interface (I/F) 204 for communicating with the outside, a display mechanism 205 including a video memory, a display, and the like, and an input device 206 such as a keyboard and a mouse.

More specifically, these functional units are realized by the CPU 201 reading and executing programs realizing the image information acquisition unit 101, the machine translation unit 102, the correction area detection unit 103, the result display unit 104, the correction unit 105, the correction instruction receiving unit 106, the output instruction receiving unit 107, the translation result output unit 108, the character recognition unit 109, and the like, from the magnetic disk device 203 into the main memory 202.

Further, the program realizing the exemplary embodiment of the present invention can be provided not only by a communication unit but also by being stored in a recording medium such as a CD-ROM.

Although various exemplary embodiments and modifications have been described above, it goes without saying that these exemplary embodiments and modification examples may be combined.

Further, the present disclosure is not limited to the above exemplary embodiment at all, and can be implemented in various forms without departing from the gist of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires image information; and
an output unit that in a case where there is an area having a degree of a difference between a state before translation and a state after translation in translation of a document included in an image, among areas in the image exceeding a predetermined degree, outputs information indicating a position of the area in the image.

2. The information processing apparatus according to claim 1,
wherein the output unit changes information to be output depending on the degree of the difference.

3. The information processing apparatus according to claim 1,
wherein the output unit changes information to be output depending on a type of the area.

4. The information processing apparatus according to claim 2,
wherein the output unit changes an image to be added within a predetermined range from the area, as the information to be output.

5. The information processing apparatus according to claim 3,
wherein the output unit changes an image to be added within a predetermined range from the area, as the information to be output.

6. The information processing apparatus according to claim 1, further comprising:
a presentation unit that presents a candidate for a correction procedure for correcting the difference.

7. The information processing apparatus according to claim 2, further comprising:
a presentation unit that presents a candidate for a correction procedure for correcting the difference.

8. The information processing apparatus according to claim 3, further comprising:
a presentation unit that presents a candidate for a correction procedure for correcting the difference.

9. The information processing apparatus according to claim 4, further comprising:
a presentation unit that presents a candidate for a correction procedure for correcting the difference.

10. The information processing apparatus according to claim 5, further comprising:
a presentation unit that presents a candidate for a correction procedure for correcting the difference.

11. The information processing apparatus according to claim 6,
wherein the correction procedure has a plurality of formats, and
wherein the presentation unit changes a format of the correction procedure to be presented as the candidate, depending on a type of the area.

12. The information processing apparatus according to claim 7,
wherein the correction procedure has a plurality of formats, and
wherein the presentation unit changes a format of the correction procedure to be presented as the candidate, depending on a type of the area.

13. The information processing apparatus according to claim 8,
wherein the correction procedure has a plurality of formats, and
wherein the presentation unit changes a format of the correction procedure to be presented as the candidate, depending on the type of the area.

14. The information processing apparatus according to claim 9,
wherein the correction procedure has a plurality of formats, and
wherein the presentation unit changes a format of the correction procedure to be presented as the candidate, depending on a type of the area.

15. The information processing apparatus according to claim 10,
wherein the correction procedure has a plurality of formats, and
wherein the presentation unit changes a format of the correction procedure to be presented as the candidate, depending on the type of the area.

16. The information processing apparatus according to claim 1,
wherein the predetermined degree is set relative to the degree of the difference for each area in the image.

17. The information processing apparatus according to claim 2,
wherein the predetermined degree is set relative to the degree of the difference for each area in the image.

18. The information processing apparatus according to claim 16,
wherein the predetermined degree is set such that a ratio of areas having the degree of the difference exceeding the predetermined degree to areas in the image is a specific ratio.

19. An information processing apparatus comprising:
a replacement unit that replaces a document of a first language disposed in a predetermined layout in an image with a document of a second language; and
a presentation unit that in a case where the predetermined layout is compared with a layout after translation in which the translated document of the second language is disposed, and a degree of a difference between the predetermined layout and the layout after translation exceeds a predetermined degree, presents an area having the difference.

20. A non-transitory computer readable medium storing a program causing a computer to realize:
a function of acquiring image information; and
a function of, in a case where there is an area having a degree of a difference between a state before translation and a state after translation when a document included in an image is translated exceeding a predetermined degree, among areas in the image, outputting information indicating the position of the area in the image.
